(19) United States
(12) Patent Application Publication
(10) Pub. No.: US 2007/0125855 A1
(43) Pub. Date: Jun. 7, 2007

(54) CHIP CARD RETAINING MECHANISM

(75) Inventors: Mao-Fa Jiang, Shenzhen (CN); Chia-Hua Chen, Shindian (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO.,LTD., Shindian (TW)

(21) Appl. No.: 11/309,512

(22) Filed: Aug. 15, 2006

(30) Foreign Application Priority Data
Dec. 2, 2005 (CN) 200510102012.6

(51) Int. Cl. G06K 7/06; G06K 7/00

(52) U.S. Cl. 235/441; 235/486

(57) ABSTRACT

A chip card retaining mechanism for retaining a chip card (50) mounted in an electronic device, the electronic device including a housing (10). The chip card retaining mechanism includes a receiving portion, and a locking member (20). The receiving is formed on the housing for fittingly receiving the chip card therein. The locking member is slidably mounted on the housing and positioned over the receiving portion such that if the chip card is received in the receiving portion, the locking member stably locks the chip card in the receiving portion.

### FIELD OF THE INVENTION

The present invention generally relates to chip card retaining mechanisms and, more particularly, to a chip card retaining mechanism for seating a chip card in an electronic device such as a mobile phone.

### DESCRIPTION OF RELATED ART

Nowadays, electronic devices such as mobile phones are widely used and bring convenience to our lives, as such, electronic devices have become a part of modern life. Every electronic device has a chip card such as a SIM (subscriber identification module) card for carrying information necessary for operating the mobile phone. The chip card may also contain personal information for the subscriber, for example, a listing of frequently used telephone numbers. However, it is necessary to provide a chip card retaining mechanism to hold the chip card in the electronic device.

Referring to FIG. 5, a typical chip card retaining mechanism used in a mobile phone is as follows. The chip card retaining mechanism includes a mounting base 52 and a locking element 54. A receiving groove 520 is defined in the mounting base 52 for receiving a chip card. A connector 50 is disposed in the receiving groove 520. The locking element 54 is mounted on the mounting base 52 and located adjacent to the receiving groove 520. The locking element 54 can move in a direction shown by an arrow. In assembly, the locking element 54 is pushed away from the receiving groove 520 to completely expose the receiving groove 520. A SIM card is received in the receiving groove 520, and the locking element 54 is pushed toward the receiving groove 520 to cover a portion of the receiving groove 520 so that the SIM card cannot be removed from the receiving groove 520.

Although the locking element 54 can be easily moved to assembly the SIM card, when a mobile phone inadvertently undergoes impact, this impact may result in an outer force which removes the locking element 54 remove from the receiving groove 520, which can result in an ineffective electrical connection between the SIM card and the connector 50. At worst, the SIM card may become completely separated from the receiving groove 520, which badly affects stability of the mobile phone.

What is needed, therefore, is a chip card retaining mechanism which overcomes the above-described shortcomings.

### SUMMARY OF THE INVENTION

In a first preferred embodiment, a chip card retaining mechanism for retaining a chip card mounted in an electronic device, the electronic device including a housing. The chip card retaining mechanism comprises a receiving portion, and a locking member. The receiving portion is formed on the housing for fittingly receiving the chip card therein. The locking member is slidably mounted on the housing and positioned over the receiving portion such that if the chip card is received in the receiving portion, the locking member can stably lock the chip card in the receiving portion.

Other advantages and novel features of the preferred embodiments of the present chip card retaining mechanism and its applications will become more apparent from the following detailed description when taken in conjunction with the accompanying drawings.

### BRIEF DESCRIPTION OF THE DRAWINGS

Many aspects of the present chip card retaining mechanisms and their applications can be better understood with reference to the following drawings. The components in the drawings are not necessarily drawn to scale, the emphasis instead being placed upon clearly illustrating the principles of the chip card retaining mechanisms. Moreover, in the drawings, like reference numerals designate corresponding parts throughout the several views.

FIG. 1 is an isometric view of an electronic device, which employs a chip card retaining mechanism in accordance with a preferred embodiment.

FIG. 2 is an exploded, isometric view of the chip card retaining mechanism of FIG. 1, showing a first position of the locking member;

FIG. 3 is an assembled, isometric view of the chip card retaining mechanism of FIG. 2, showing a second position of the locking member;

FIG. 4 is an cross-sectional view taken along line V-V of FIG. 4; and

FIG. 5 is an exploded, isometric view of a typical chip card retaining mechanism.

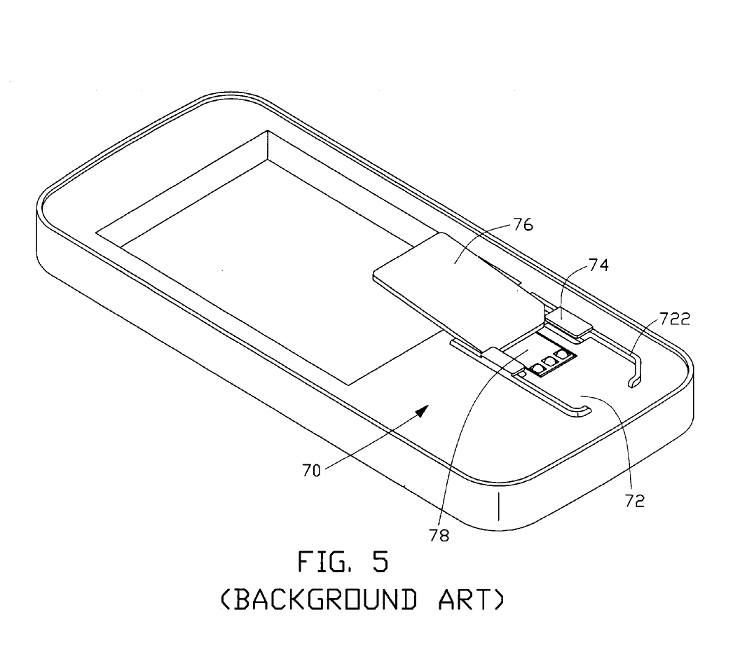

### DETAILED DESCRIPTION OF THE INVENTION

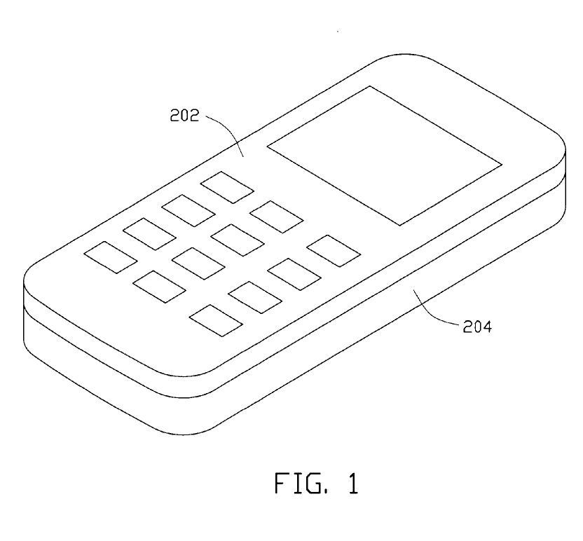

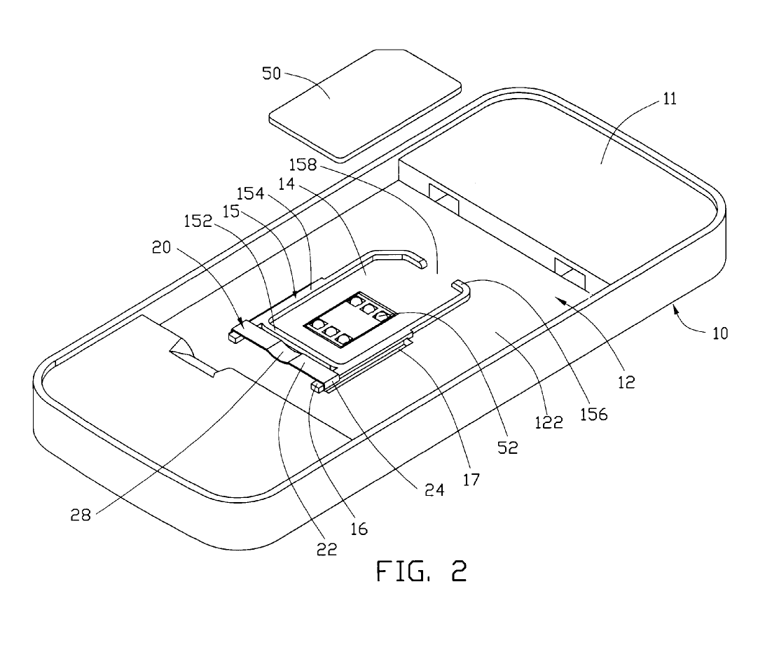

A chip card retaining mechanism is adapted for retaining a chip card in an electronic device such that the chip card is electrically connected with a connector in the electronic device. Referring to FIG. 1, the chip card retaining mechanism is applied to an exemplary mobile phone 200, which includes a front cover 202, a housing 10, and a rear cover 204. The front cover 202 and the rear cover 204 cooperatively define an enclosed space. The housing 10 is mounted in the enclosed space. Referring to FIG. 2, in order to identify the used mobile phone, when communicating, a chip card 50, such as a subscriber identification module, also called SIM card, is provided. The housing 10 has a battery compartment 12 (partly shown) defined in an upper surface portion 11 thereof and defined by a bottom surface 122. The chip card 50 is electrically connected to a printed circuit board (PCB, not shown) by a connector 52. The battery compartment 12 is for receiving a battery (not shown).

The chip card retaining mechanism includes a receiving portion such as a receiving groove 14 for receiving the chip card 50, and a locking member 20.

The receiving groove 14 is disposed on a center of the bottom surface 122 of the battery compartment 12, corresponding to the chip card 50. A strip 15 protrudes from the bottom surface 122 of the battery compartment 12. The strip 15 and a portion of the bottom surface 122 cooperatively define the receiving groove 14. The strip 15 includes a first end portion 152, two parallel side portions 154, and an opposite second end portion 156. Two parallel extending portions 16 extend from the two side portions 154 along a direction toward the first end portion 152. The second end portion 156 defines an opening 158 for allowing the removal of the chip card 50. Two parallel guide slits 17 are defined in the bottom surface 122 and adjacent to corresponding side portions 154. Each guide slit 17 is arranged to extend from one end of the extending portion 16 to a center of a respective side portion 154 along a longitudinal direction. Each guide slit 17 is also arranged to transversely underlie a respective side portion 154. Each side portion 154 and the corresponding extending portion 16 thus may function as a guide rail.

The chip card 50 carries information that is necessary for operating the telephone and personal information of the owner and may be an integrated circuit card. The chip card 50 is electrically connected to a printed circuit board (PCB, not shown) by a connector 52. The connector 52 is secured in the housing 10 and disposed in a middle of receiving groove 14.

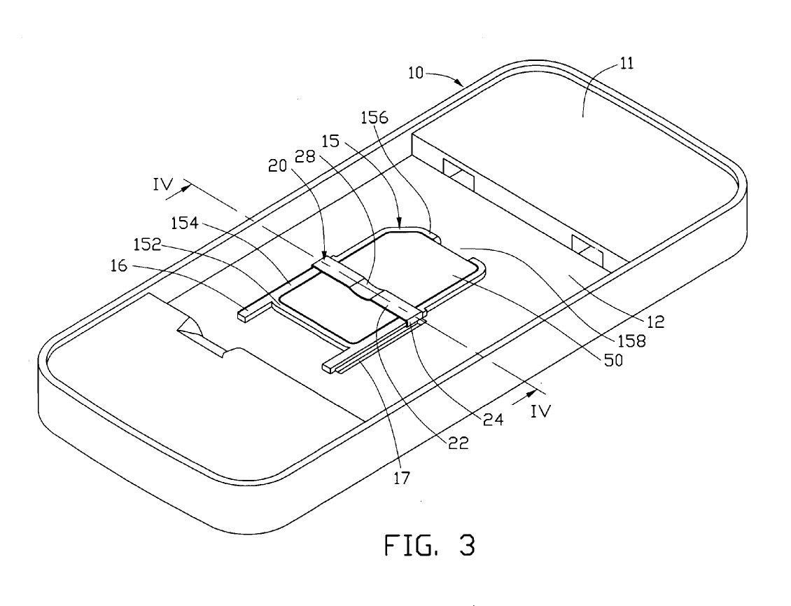

Referring to FIG. 3, the locking member 20 is an elastic board. The locking member 20 includes a body 22, two opposite resisting portions 24 extending from two opposite distal ends thereof, and two latching portions 26 extending from the resisting portions 24 toward each other, thus forming two opposite guide slots 242. The guide slots 242 engage with the guide rails of the receiving groove 14. Each latching portion 26 is parallel to the body 22. Each latching portion 26 can be slidably received in a corresponding guide slit 17, thus stably attaching the locking member 20 to the housing 10. The body 22 has an arcuate recess 28 recessed from a middle of a first surface thereof, thus forming an arcuate protrusion 230 functioning as a pressing portion on an opposite second surface thereof.

Referring back to FIG. 2, in assembling the locking member 20 to the housing 10, one latching portion 26 of the locking member 20 is received in one guide slit 17, with one guide slot 242 engaging with one corresponding guide rail. The other latching portion 26 of the locking member 20 is pressed into the other guide slit 17. Therefore, the locking member 20 is stably attached to the housing 10 and can slide on the housing 10 between a first position and a second position under engagement between the guide slots 242 and the guide rails.

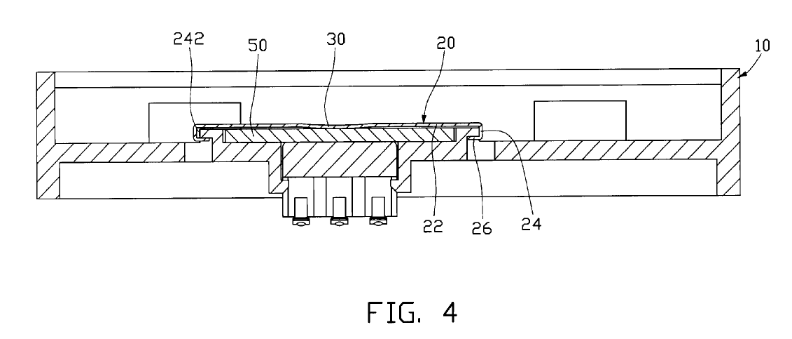

Referring to FIGS. 2-4, in assembling and mounting the chip card 50, the locking member 20 is pushed to the extending portion 16 and is in a first position as shown in FIG. 2. The chip card 50 lies in the receiving groove 14. When the chip card 50 is completely contained in the receiving groove 14, the locking member 20 is pushed in a direction toward the second end portion 156 of the receiving groove 14 until the locking member 20 reaches at the second position, this is at the middle of the side portions 154. In this state, the arcuate protrusion 30 elastically abuts the chip card 50, thus stably locking the chip card 50 in the receiving groove 14. Thus, the chip card 50 is stably mounted in the receiving groove 14, and an effective electrical connection between the chip card 50 and the connector 52 is provided. In addition, when mounting the battery in the battery compartment 12, the battery presses on the locking member 20, which further ensures an effective electrical connection between the chip card 50 and the connector 52.

When removing the chip card 50, the locking member 20 is pushed to the extending portion 16. As such, the chip card 50 can be removed from the housing 10 via the opening 158.

In an alternative embodiment, the latching portions 26 may extend from the resisting portions 24 outwardly. Thus, the guide slits 17 extend transversely in a direction opposite to the side portions 154. The guide slits 17 may be defined in a side surface of the side portions 154.

In a further alternative embodiment, the receiving groove 14 may be recessed from the bottom surface 122 of the battery compartment 12, thus the strip 15 may be omitted. In this embodiment, the guide slits 17 may be defined in the bottom surface 122 and adjacent to two sides of the receiving groove 14.

A main advantage of the chip card retaining mechanism is that there is little friction produced between the chip card 50 and the connector 52 because the chip card 50 lies in the receiving groove 14 in a top of the receiving groove 14. Thus, the connector 52 has relatively long working lifetime. In addition, the arcuate protrusion 30 of the locking member 20 vertically presses a portion of the chip card 50 which contacts the connector 52, which ensures an effective electrical connection between the chip card 50 and the connector 52.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A chip card retaining mechanism for retaining a chip card mounted in an electronic device, the electronic device including a housing, the chip card retaining mechanism comprising:
a receiving portion formed on the housing for fittingly receiving the chip card therein; and
a locking member slidably mounted on the housing and positioned over the receiving portion such that if the chip card is received in the receiving portion, the locking member stably locks the chip card in the receiving portion;
wherein the locking member is made of a single piece of resilient material, and the locking member forms a pressing portion by deforming the locking member into the receiving portion.

2. The chip card retaining mechanism as claimed in claim 1, wherein the locking member has a body provided with a pressing portion formed thereon and facing the receiving portion for abutting the chip card.

3. The chip card retaining mechanism as claimed in claim 2, wherein the pressing portion is an arcuate protrusion.

4. The chip card retaining mechanism as claimed in claim 2, wherein the locking member further comprises two parallel guide slots formed at two opposite end thereof, and the receiving portion has two parallel guide rails formed thereon, the locking member sliding over the receiving portion on the housing by engagement of the guide rails and the guide slots.

5. The chip card retaining mechanism as claimed in claim 4, wherein the receiving portion is a receiving groove defined by a strip protruding from a surface of the housing, and the strip has two parallel side portions which function as the guide rails.

6. The chip card retaining mechanism as claimed in claim 5, wherein the locking member further comprises two resisting portions extending vertically from two distal ends of the body, and two opposite latching portions extending from the two resisting portions, and the guide slot is formed by one resisting portion and one corresponding latching portion.

7. The chip card retaining mechanism as claimed in claim 6, wherein two extending portion are formed on the housing extending from corresponding side portions of the receiving portion, and two parallel guide slits are defined in the surface of the housing adjacent to side portions and transversely extending to underlie the side portions.

8. The chip card retaining mechanism as claimed in claim 7, wherein each latching portion of the locking member is latched in one guide slit to prevent the locking member separating from the housing.

9. The chip card retaining mechanism as claimed in claim 8, wherein the receiving portion is a receiving groove recessed from an surface of the housing, and two parallel guide slits are defined in the surface of the housing each adjacent to two parallel sides of the receiving portion.

10. A chip card retaining mechanism for retaining a chip card mounted in an electronic device, the electronic device including a housing, the chip card retaining mechanism comprising:
a receiving portion formed on the housing for fittingly receiving the chip card therein; and
a locking member mounted on the housing and linearly movable between a first position and a second position, the locking member having an pressing portion formed thereof;
wherein when the locking member is in the second position, the pressing portion of the locking member abuts the chip card.

11. The chip card retaining mechanism as claimed in claim 10, wherein the locking member is an elastic board.

12. The chip card retaining mechanism as claimed in claim 11, wherein the locking member includes a pair of guide slots, and the receiving portion has a pair of guide rails, the guide rails engaging with the guide slots.

13. The chip card retaining mechanism as claimed in claim 11, wherein the locking member includes a body, two resisting portions vertically extending from two distal ends of the body, and two opposite latching portions extending from the two resisting portions, and the guide slot is formed by one resisting portion and one corresponding latching portion.

14. The chip card retaining mechanism as claimed in claim 11, wherein the receiving portion is a receiving groove defined by a strip protruding from a surface of the housing, and the strip has two parallel side portions which function as the guide rails.

15. The chip card retaining mechanism as claimed in claim 10, wherein two extending portion are formed on the housing extending from corresponding side portions of the receiving portion, and a pair of guide slits are defined in the surface of the housing, the guide slits each longitudinally extending from an end of the extending portion to a center of the side portions and transversely extending into a bottom of the side portions.

16. The chip card retaining mechanism as claimed in claim 15, wherein each latching portion of the locking member is inserted into one guide slit to prevent the locking member separating from the housing.

17. The chip card retaining mechanism as claimed in claim 10, wherein when the locking member is in the first position, the locking member spans over the two extending portions.

18. A portable electronic device comprising:
a housing having a surface defining a card receiving portion configured for releasably receiving a chip card therein, the receiving portion including a pair of opposite sides; and
a locking member bridged between the opposite sides and slidable between a first position allowing insertion/removal of the chip card into/from the receiving portion and a second position locking the chip card in the receiving portion, wherein the locking member forms a pressing portion at a substantial center portion thereof for resiliently abutting against the chip chard along a direction perpendicular to the surface.

19. The portable electronic device of claim 18, wherein the locking member is made of a single sheet of resilient material.

20. The portable electronic device of claim 19, wherein the locking member is a substantially elongated strip with two opposite ends slidably engaging with the opposite sides of the receiving portion, and the pressing portion is formed by deforming the substantially center portion of the strip toward the receiving portion.
